(19) United States
(12) Patent Application Publication
(10) Pub. No.: US 2008/0008858 A1
(43) Pub. Date: Jan. 10, 2008

(54) Roofing Products Containing Phase Change Materials

(76) Inventors: Keith C. Hong, Lititz, PA (US); Ming Liang Shiao, Collegeville, PA (US)

Correspondence Address: PAUL AND PAUL, 2000 MARKET STREET, SUITE 2900, PHILADELPHIA, PA, 19103, US

(21) Appl. No.: 11/769,530

(22) Filed: Jun. 27, 2007

Related U.S. Application Data
(60) Provisional application No. 60/806,777, filed on Jul. 8, 2006.

(51) Int. Cl. B32B 3/00

(52) U.S. Cl. 428/143; 428/141

(57) ABSTRACT

A solar heat responsive roofing material includes a continuous phase and dispersed discontinuous phase having a phase transition at a temperature between about 50 degrees Celsius and about 95 degrees Celsius.

### CROSS-REFERENCE TO RELATED APPLICATION

The present application claims the priority of provisional application Ser. No. 60/806,777 filed Jul. 8, 2006.

### BACKGROUND OF THE INVENTION

1. Field of the Invention

The present invention relates to roofing products, and processes for making such products.

2. Brief Description of the Prior Art.

Roofing products include sheet or roll roofing employed in constructing built-up roofs and mineral-surfaced asphalt shingles. Depending on the specifics of their installation, roofing products can experience significant thermal shocks on a repeated basis, reducing the service life of the roof in which they are installed. For example, a dark colored, south-facing shingled roof installed at a location at a high elevation can experience a significant rise in temperature shortly after sunrise on a cloudless day.

Sheet roofing products are typically employed for flat or gently sloping roofs. Built-up roofing typically includes one or more sheets of polymer-modified bitumen, strengthened with a nonwoven fibrous mat bonded with hot asphalt or a cold adhesive. Roofing sheets formed from elastomeric materials such as EDPM rubber and thermoplastic materials such as thermoplastic polyolefin are also employed to cover flat roofs.

Mineral surfaced asphalt shingles, such as those described in ASTM D225 (“Standard Specification for Asphalt Shingles (Organic Felt) Surfaced with Mineral Granules”) or D3462 (“Standard Specification for Asphalt Shingles Made From Glass Felt and Surfaced with Mineral Granules”), are generally used on steep-sloped roofs to provide water-shedding function while adding an aesthetically pleasing appearance to the roofs. The asphalt shingles are generally constructed from asphalt-saturated roofing felts and surfaced with pigmented color granules, such as those described in U.S. Pat. No. 4,717,614. Pigment-coated mineral rocks are commonly used as color granules in roofing applications to provide aesthetic as well as protective functions to the asphalt shingles. Roofing granules are generally used in asphalt shingle or in roofing membranes to protect asphalt from harmful ultraviolet radiation.

Roofing granules typically comprise crushed and screened mineral materials, which are subsequently coated with a binder containing one or more coloring pigments, such as suitable metal oxides. The granules are employed to provide a protective layer on asphaltic roofing materials such as shingles, and to add aesthetic values to a roof.

In the past, pigments for roofing granules have usually been selected to provide shingles having an attractive appearance with little thought to the thermal stresses encountered on shingled roofs. However, depending on location and climate, roofs, including shingled roofs, can experience very challenging environmental conditions, which tend to reduce the effective service life of such roofs. One significant environmental stress is the elevated temperature experienced by roofing shingles under sunny, summer conditions, especially roofing shingles coated with dark colored roofing granules.

Conventional built-up roofs and conventional asphalt shingles are known to have low solar heat reflectance, and hence will absorb solar heat especially through the near infrared range (700 nm-2500 nm) of the solar spectrum. In the case of granule-covered roofing, this phenomenon is increased as the granules covering the surface become dark in color. For example, while white-colored asphalt shingles can have solar reflectance in the range of 25-35%, dark-colored asphalt shingles can have solar reflectance of only 5-15%. Furthermore, except in the white or very light colors, there is typically only a very small amount of pigment in the conventional granule's color coating that reflects solar radiation well. As a result, it is common to measure temperatures as high as 77° C. on the surface of black roofing shingles on a sunny day with 21° C. ambient temperature. Absorption of solar heat may result in elevated temperatures at the shingle's surroundings, which can contribute to the so-called heat-island effects and increase the cooling load to its surroundings or energy consumption needs for air conditioning.

This heat absorption problem has been addressed by applying white pigment-containing latex coatings directly onto the surface on the roof. Although such roofs can be coated with solar reflective paint or coating material, such as a composition containing a significant amount of titanium dioxide pigment, in order to reduce such thermal stresses, this utilitarian approach will often prove to be aesthetically undesirable, especially for residential roofs. This approach has primarily been employed for commercial and industrial building roofs. Depending on the environment, such roofs can become soiled rapidly, substantially reducing the reflectivity of the roof. Periodic renewal of the coating may be required. White reflective pigments have also been incorporated in roofing sheets, such as roofing membranes formed from thermoplastic polyolefin.

Another approach is provided by U.S. Pat. No. 2,732,311, which discloses a method for preparing roofing granules having metal flakes, such as aluminum flakes, adhered to their surfaces, to provide a radiation-reflective surface. Additionally, the use of exterior-grade coatings colored by infrared-reflective pigments for deep-tone colors, and sprayed onto the roof in the field, has been proposed. Employing another approach, U.S. Patent Publication 2003/0068469 A1 discloses an asphalt-based roofing material comprising a mat saturated with asphalt coating and a top coating having a top surface layer that has a solar reflectance of at least 70%. The high reflectance of the top surface layer is achieved by embedding metal flakes or a reflective pigment such as titanium dioxide or zinc sulfide in surface layer (paragraph 48). Alternatively, minerals with high solar reflectance can be selected and employed as roofing granules. For example, U.S. Patent Publication 2003/0152747 A1 discloses the use of granules with solar reflectance greater than 55% to enhance the solar reflectivity of asphalt based roofing products. U.S. Patent Publication 2005/0072114 A1 discloses solar-reflective roofing granules having deep-tone colors that are formed by coating base mineral particles with a coating composition including an infrared-reflective pigment. Color is provided by a colored infrared pigment, light-interference platelet pigment, or metal oxide. U.S. Patent Publication 2005/0072110 A1 discloses an infrared-reflective material applied directly to the bituminous surface of a roofing product to increase the solar heat reflectance of the product, even when deep-tone roofing granules are used to color the product. The infrared-reflective material can be applied as a powder or in a carrier fluid or film, and can be applied along with infrared-reflective roofing granules.

Phase change materials (“PCM”) are materials intended to store heat energy for later release. Uses include modification of textiles used in extreme or hazardous environments, and modified wallboard for energy conservation and reducing peak power demand. Heat is either absorbed or released to effect a phase change, such as when a material melts or solidifies.

U.S. Pat. No. 5,770,295 discloses a phase change thermal insulation system, which includes an inner layer of insulating material and an outer layer of insulating material with an intermediate layer of phase change material in between the insulating layers.

U.S. Patent Application Publication No. 2004/0170806 discloses tile structures having a PCM component for use in flooring and ceilings. The PCM component can be an encapsulated paraffin wax. The tiles preferably include a binder material such as a polyester resin or styrene monomer, a PCM component, and a granular base medium such as a granular-sized stone.

There is a continuing need for roofing materials, and especially asphalt shingles, that have improved resistance to thermal stresses while providing an attractive appearance.

### SUMMARY OF THE INVENTION

The present invention provides roofing materials and roofs formed therefrom that have improved resistance to thermal stresses and which simultaneously provide an attractive appearance.

In one embodiment, the present invention provides a solar heat responsive roofing material comprising a continuous phase, and a discontinuous phase dispersed in the continuous phase, where the discontinuous phase has a phase transition at a temperature between about 50 degrees Celsius and about 95 degrees Celsius, and preferably between about 60 degrees Celsius and about 85 degrees Celsius. Preferably, the discontinuous phase has a phase transition enthalpy of at least about 100 kilojoules per kg, and preferably constitutes at least ten percent by weight of the roofing material, and more preferably at least about twenty-five percent by weight of the roofing material. Preferably, the wherein the discontinuous phase comprises a lipophilic substance. Preferably, the discontinuous phase of the roof comprises at least one heat-responsive substance selected from the group comprising high temperature waxes and thermoplastic polymers, and the thermoplastic polymer is preferably selected from the group consisting of poly(vinyl ethyl ether), poly(vinyl n-butyl ether) and polychloroprene. In one aspect of the present embodiment of the invention, the roofing material includes a base sheet having a bituminous coating comprising the continuous phase. In another aspect, the roof includes a plurality of coated roofing granules, and the continuous phase comprises the roofing granule coating. In one presently preferred aspect of the present invention, the discontinuous phase is encapsulated in a plurality of capsules. In this case, the capsules preferably include a capsule wall, and the capsule wall is preferably formed from a material selected from the group consisting of poly(meth)acrylates and polyurethanes. In this case, the capsules preferably have a size ranging from about 1 micrometers to 100 micrometers, and more preferably a size ranging from about 2 micrometers to 50 micrometers. In another aspect of the present invention, the discontinuous phase comprises a plurality of fibers comprising phase change material.

In another embodiment, the present invention provides a solar heat-responsive roofing material comprising a bituminous base sheet; and a plurality of roofing granules, the roofing granules including a latent heat storage material having a phase transition at a temperature between about 50 degrees Celsius and about 95 degrees Celsius, and preferably between about 60 degrees Celsius and about 85 degrees Celsius. Preferably, the heat storage material has a phase transition enthalpy of at least 100 kilojoules per kg, and preferably the heat storage material constitutes at least ten percent by weight of the roofing material, and more preferably at least thirty percent by weight of the roofing material. Preferably, the heat storage material is a lipophilic substance. Preferably, the heat storage material is selected from the group comprising high temperature waxes and thermoplastic polymers, wherein the thermoplastic polymer is preferably selected from the group consisting of poly(vinyl ethyl ether), poly(vinyl n-butyl ether) and polychloroprene. In one aspect of this embodiment, the heat storage material is encapsulated in a plurality of capsules. Preferably, the capsules each include a capsule wall, and the capsule wall is formed from a material selected from the group consisting of poly(meth)acrylates and polyurethanes. In this case, the capsules preferably have a size ranging from about 0.1 millimeters to 10 millimeters, and more preferably ranging from about 0.5 millimeters to 2 millimeters. In another aspect of this embodiment, the bituminous base sheet preferably includes a plurality of fibers comprising phase change material.

In yet another embodiment, the present invention provides a solar heat-responsive roofing material comprising at least one solar-heat reflective material; and at least one latent-heat storage material, the at least one latent-heat storage material having a phase transition at a temperature between about 50 degrees Celsius and about 95 degrees Celsius, and preferably between about 60 degrees Celsius and about 85 degrees Celsius. Preferably, the latent-heat storage material has a phase transition enthalpy of at least about 100 kilojoules per kg. Preferably, the heat storage material constitutes at least ten percent by weight of the roofing material, and more preferably at least about thirty percent by weight of the roofing material. Preferably, the heat storage material is a lipophilic substance. Preferably, the heat storage material comprises at least one heat-responsive substance selected from the group comprising high temperature waxes and thermoplastic polymers, and the thermoplastic polymer is preferably selected from the group consisting of poly(vinyl ethyl ether), poly(vinyl n-butyl ether) and polychloroprene. In this embodiment of the present invention, the at least one solar heat reflective roofing material preferably has greater than 40% total reflectance between 700 nm to 2500 nm of solar radiation. In this embodiment, the solar heat-responsive roofing material preferably includes a continuous phase, and a discontinuous phase dispersed in the continuous phase, wherein the discontinuous phase includes the latent-heat storage material. In one aspect of this embodiment, the roofing material preferably includes a base sheet having a bituminous coating comprising the continuous phase. In this aspect of this embodiment, the roofing material preferably includes a plurality of coated roofing granules, and the continuous phase comprises the roofing granule coating. In one variation of this embodiment, the discontinuous phase is preferably encapsulated in a plurality of capsules. In this variation, the capsules each include a capsule wall, and the capsule wall is preferably formed from a material selected from the group consisting of poly(meth)acrylates and polyurethanes. Preferably, the capsules have a size ranging from about 1 micrometer to 100 micrometers, and more preferably from about 2 micrometers to 50 micrometers.

In one aspect of this embodiment of the present invention, the solar-reflective roofing preferably includes a bituminous base sheet; and a plurality of roofing granules, and the roofing granules include the latent-heat storage material. In this case, the storage material is preferably encapsulated in a plurality of capsules. Here, the capsules preferably include a capsule wall, with the capsule wall being formed from a material selected from the group consisting of poly(meth)acrylates and polyurethanes. In this case, the capsules preferably have a size ranging from about 0.1 millimeters to 10 millimeters, more preferably from about 0.5 millimeters to 2 millimeters.

In another aspect of this embodiment of the present invention, the solar heat-responsive roofing material preferably includes a reflective coating, and the solar-heat responsive material is dispersed in the reflective coating. In this aspect, the solar heat-responsive roofing material preferably comprises a bituminous base sheet; and a plurality of roofing granules, with the roofing granules including the latent-heat storage material. In one variation of this aspect of the present invention, the reflective coating is preferably applied to the bituminous base sheet. In another variation of this aspect of the present embodiment, the reflective coating is preferably applied to the roofing granules.

### BRIEF DESCRIPTION OF THE DRAWINGS

FIG. 1 is a schematic illustration of a solar heat responsive roofing material according to a first embodiment of the present invention.

FIG. 2 is a schematic illustration of a solar heat responsive roofing material according to a second embodiment of the present invention.

FIG. 3 is a schematic illustration of a solar heat responsive roofing material according to a third embodiment of the present invention.

FIG. 4 is a schematic illustration of a solar heat responsive roofing material according to a fourth embodiment of the present invention.

FIG. 5 is a schematic illustration of a solar heat responsive roofing material according to a fifth embodiment of the present invention.

FIG. 6 is a schematic illustration of a solar heat responsive roofing material according to a sixth embodiment of the present invention.

FIG. 7 is a schematic illustration of a solar heat responsive roofing material according to a seventh embodiment of the present invention.

FIG. 8 is a schematic illustration of a solar heat responsive roofing material according to a eighth embodiment of the present invention.

FIG. 9 is a schematic illustration of a solar heat responsive roofing material according to a ninth embodiment of the present invention.

### DETAILED DESCRIPTION

The present invention provides roofing materials and roofs formed therefrom that have improved resistance to thermal stresses by the inclusion of suitable phase change material in the roofing materials.

Phase change materials for use in the roofing materials of the present invention preferably have a phase transition at a temperature between about 50 degrees Celsius and about 95 degrees Celsius, and more preferably between about 60 degrees Celsius and about 85 degrees Celsius. Preferably, the latent heat accompanying the phase change is at least about 100 kilojoules per kilogram. The phase change experienced by the phase change material depends upon the specific phase change material employed, but can be fusion or crystallization, or another type of phase change, such as eutectic melting or transitions between solid phases. Preferably, the phase change does not result in a substantial volume change, as in the case of vaporization. Preferably, the phase change material is a chemically inert material, or a material with limited chemical reactivity.

Preferably, the phase change material is selected from the higher paraffins, and in particular, from the paraffins having a melting point within the preferred phase transition temperature range, including, for example, n-tetracosane (melting point 50.9 degrees C., latent heat of fusion 255 kJ/kg), n-pentacosane (melting point 53.7 degrees C., latent heat of fusion 238 kJ/kg), n-hexacosane (melting point 56.4 degrees C., latent heat of fusion 257 kJ/kg), n-heptacosane (melting point 59.0 degrees C., latent heat of fusion 236 kJ/kg), n-octacosane (61.4 degrees C., latent heat of fusion 255 kJ/kg), n-nonacosane (melting temperature 64 degrees C., latent heat of fusion 240 kJ/kg), n-triacontane (melting temperature 65 degrees C., latent heat of fusion, 252 kJ/kg), n-hentriacontane, n-dotriacontane (melting point 70 degrees C.) n-tritriacontane (melting point 71 degrees C., latent heat of fusion 189 kJ/kg), and mixtures thereof. Suitable mixtures may include lower paraffins, such as, for example, n-dodecane, n-tridecane, n-tetradecane, n-pentadecane, n-hexadecane, n-heptadecane, n-octadecane, n-nonadecane, n-eiscosane, n-heneicosane, n-docosane, and n-tricosane. However, the average melting point of such mixtures is preferably between about 50 degrees Celsius and about 93.3 degrees Celsius, and more preferably between about 60 degrees Celsius and about 82.2 degrees Celsius.

Preferably, the phase change composition is selected so that subcooling is avoided. For example, when a paraffinic phase change material is employed, it is preferred that a nucleating agent be included in the composition when phase change material is provided in a finely distributed phase, such as disclosed for example, in U.S. Patent Publication 2004/0076826. Suitable nucleating agents include paraffinic alcohols and amines, such as, for example, 1-hexacosanol, 1-pentacosanol, 1-tridecanol, pentadecylamine, eicosylamine, and docosylamine.

Other phase change materials that can be employed in the present invention include fatty acids, salt hydrates and other inorganic materials, eutectic mixtures, esters, alcohols and glycols. Suitable inorganic materials include antimony trichloride (melting point 73.4 degrees C., latent heat of fusion 25 kJ/kg). Suitable organic materials include camphene (melting point 50 degrees C., latent heat of fusion 238 kJ/kg), 9-heptadecanone (melting point 51 degrees C., latent heat of fusion 213 kJ/kg), methyl behenate (melting point 52 degrees C., latent heat of fusion 234 kJ/kg), pentadeconoic acid (melting point 52.5 degrees C., latent heat of fusion 178 kJ/kg), hypophosphoric acid (H4P2O6, melting point 55.0 degrees C., latent heat of fusion 213 kJ/kg), choroacetic acid (melting point 56 degrees C., latent heat of fusion 130 kJ/kg), potassium octanoate (melting point 57 degrees C.), heptadecanoic acid (melting point 60.6 degrees C., latent heat of fusion 189 kJ/kg), potassium heptanoate (melting point 61 degrees C.), bees wax (melting point 61.8 degrees C., latent heat of fusion 177 kJ/kg), glycolic acid (melting point 63 degrees C., latent heat of fusion 109 kJ/kg), ammonium biacetate (melting point 65-66 degrees C., latent heat of fusion 146-159 kJ/kg), n-eicosanoic acid (melting point 76.5 degrees C., latent heat of fusion 227 kJ/kg), (+)-3-bromocamphor (melting point 77 degree C., latent heat of fusion 174 kJ/kg), potassium propionate (melting point 79 degrees C.), durene (melting point 79.3 degrees C., latent heat of fusion 156 kJ/kg), acetamide (meting point 81 degrees C., latent heat of fusion 241 kJ/kg), and methyl 4-bromobenzoate (melting point 81 degrees C., latent heat of fusion 126 kJ/kg). Suitable fatty acids for use as PCM in the present invention include myristic acid (melting point 49-51 degrees C., latent heat of fusion 205 kJ/kg), palmitic acid (melting point 64 degrees C., latent heat of fusion 185.4 kJ/kg) and stearic acid (melting point 69 degrees C., latent heat of fusion 202.5 kJ/kg). Suitable salt hydrates include Ca(NO₃)₂.3H2O (melting point 51 degrees C., latent heat of fusion 104 kJ/kg), Na(NO₃)₂.6H2O (melting point 53 degrees C., latent heat of fusion 158 kJ/kg), Zn(NO₃)₂.2H2O (melting point 55 degrees C., latent heat of fusion 68 kJ/kg), FeCl₃.2H₂O (melting point 56 degrees C., latent heat of fusion 90 kJ/kg), Co(NO₃)₂.6H₂O (melting point 57 degrees C., latent heat of fusion 115 kJ/kg), Ni(NO₃)₂.6H₂O (melting point 57 degrees C., latent heat of fusion 168 kJ/kg), MnCl₂.4H₂O (melting point 58 degrees C., latent heat of fusion 151 kJ/kg), CH₃COONa.3H₂O (melting point 58 degrees C., latent heat of fusion 270-290 kJ/kg), LiC₂H₃O₂.2H₂O (melting point 58 degrees C., latent heat of fusion 251-377 kJ/kg), MgCl₂.4H₂O (melting point 58.0 degrees C., latent heat of fusion 178 kJ/kg), NaOH.H2O (melting point 58 degrees C., latent heat of fusion 272 kJ/kg), Cd(NO₃)₂.4H₂O (melting point 59 degrees C., latent heat of fusion 98 kJ/kg), Cd(NO₃)₂.1H₂O (melting point 59.5 degrees C., latent of fusion 107 kJ/kg), Fe(NO₃)₂.6H₂O (melting point 60 degrees C., latent of fusion 125 kJ/kg), NaAl(SO₄)₂.12H₂O (melting point 61 degrees C., latent of fusion 181 kJ/kg), FeSO₄.7H₂O (melting point 64 degrees C., latent of fusion 200 kJ/kg), Na₃PO₄.12H₂O (melting point 65 degrees C., latent of fusion 168 kJ/kg), Na₂B₄O₇.10H₂O (melting point 68 degrees C.), Na₃PO₄.12H₂O (melting point 69 degrees C.), LiCH₃COO.2H₂O (melting point 70 degrees C., latent of fusion 150-251 kJ/kg), Na₂P₂O₇.10H₂O (melting point 70 degrees C., latent of fusion 186-230 kJ/kg), Al(NO₃)₂.9H₂O (melting point 72 degrees C., latent of fusion 155-176 kJ/kg), Ba(OH)₂.8H₂O (melting point 78 degrees C., latent of fusion 265-280 kJ/kg), A12(SO₄)₃.18H₂O (melting point 88 degrees C., latent of fusion 218 kJ/kg), Sr(OH)₂.8H₂O (melting point 89 degrees C., latent of fusion 370 kJ/kg), Mg(NO₃)₂.6H₂O (melting point 89-90 degrees C., latent of fusion 162-167 kJ/kg), KAl(SO₄)₂.12H₂O (melting point 91 degrees C., latent of fusion 184 kJ/kg), and (NH₄)Al(SO₄).6H₂O (melting point 95 degrees C., latent of fusion 269 kJ/kg). Suitable eutectic mixtures include mixtures of 13-16 weight percent LiNO₃, 19-21 weight percent KNO₃, and 63-68 weight percent Mg(NO₃)2.6H₂O (melting point 52 degrees C.), mixtures of 61.5 weight percent Mg(NO₃).6H₂O and 38.4 weight percent NH₄NO₃ (melting point 52 degrees C., latent heat of fusion 125.5 kJ/kg), mixtures of 58.7 weight percent Mg(NO₃).6H₂O and 41.3 weight percent MgCl₂.6H₂O (melting point 59 degrees C., latent heat of fusion 132.2 kJ/kg), mixtures of 53 weight percent Mg(NO₃).6H₂O and 47 weight percent Al(NO₃)₂.9H₂O (melting point 61 degrees C., latent heat of fusion 148 kJ/kg), mixtures of 59 weight percent Mg(NO₃).6H₂O and 41 weight percent MgBr₂.6H₂O (melting point 66 degrees C., latent heat of fusion 168 kJ/kg), mixtures of 67.1 weight percent naphthalene and 32.9 weight percent benzoic acid (melting point 67 degrees C., latent heat of fusion 123.4 kJ/kg), mixtures of 10-12 weight percent LiNO₃, 6-8 percent by weight NaNO₃, and 80-84 percent by weight Mg(NO₃)2.6H₂O (melting point 67 degrees C.), mixtures of 79 weight percent AlCl₃, 17 weight percent NaCl, and 4 weight percent ZrCl2 (melting point 68 degrees C., latent heat of fusion 234 kJ/kg), mixtures of 66 weight percent AlCl₃, 20 weight percent NaCl, and 14 weight percent KCl (melting point 70 degrees C., latent heat of fusion 209 kJ/kg), mixtures of 66.6 weight percent NH₂CONH₂ and 34.4 weight percent NH4Br (melting point 76 degrees C., latent heat of fusion 151 kJ/kg), mixtures of 25 weight percent LiNO₃, 65 weight percent NH₄NO₃, and 10 weight percent NaNO₃ (melting point 80.5 degrees C., latent heat of fusion 113 kJ/kg), mixtures of 60 weight percent AlCl₃, 26 weight percent NaCl, and 14 weight percent KCl (melting point 93 degrees C., latent heat of fusion 213 kJ/kg), and mixtures of 66 weight percent AlCl₃ and 34 weight percent NaCl (melting point 93 degrees C., latent heat of fusion 201 kJ/kg). Examples of phase change materials having solid-solid phase transitions that can be employed in the present invention include diamino-pentaerythritol (solid-solid transition temperature 68 degrees C., enthalpy of phase transition 184 kJ/kg), 2-amino-2-methyl-1,3-propanediol (solid-solid transition temperature 78 degrees C., enthalpy of phase transition 264 kJ/kg), 2-methyl-2-nitro-1,3-propanediol (solid-solid transition temperature 79 degrees C., enthalpy of phase transition 201 kJ/kg), trimethylolethane (solid-solid transition temperature 81 degrees C., enthalpy of phase transition 192 kJ/kg), and monoamino-pentaerythritol (solid-solid transition temperature 86 degrees C., enthalpy of phase transition 192 kJ/kg). Examples of polymeric materials that can be employed as phase change material in the present invention include thermoplastic polymers such as poly(vinyl ethyl ether), poly(vinyl n-butyl ether) and polychloroprene, polyethylene glycols such as Carbowax™ polyethylene glycol 4600 (melting temperature 57-61 degrees C.), Carbowax polyethylene glycol 8000 (melting point temperature 60-63 degrees C., heat of fusion 167.5 kJ/kg), and Carbowax polyethylene glycol 14,000 (melting point temperature 61-67 degrees C.), and polyolefins such as lightly crosslinked polyethylene (solid-solid transition temperature 81 degrees C., enthalpy of phase transition 192 kJ/kg), and high density polyethylene (solid-solid transition temperature 125-146 degrees C., enthalpy of phase transition 167-201 kJ/kg).

The phase change materials employed in the present invention are preferably dispersed as a discontinuous phase in a continuous phase of another, non-PCM material.

Preferably, in order to facilitate preparation of the roofing materials of the present invention, the phase change materials are provided in the form of microcapsules.

The phase change material can be encapsulated in microcapsules using conventional techniques for forming microcapsules, including such techniques as interfacial polymerization, phase separation/coacervation, spray drying, spray coating, fluid bed coating, supercritical anti-solvent precipitation, and the like. Techniques for microencapsulating solid particles are disclosed, for example, in G. Beestman, “Microencapsulation of Solid Particles” (H. B. Scher, Ed., Marcel Dekker, Inc. New York 1999) pp. 31-54, Kirk-Othmer Encyclopedia of Chemical Technology, 4th Edition; as well in U.S. Pat. Nos. 6,156,245, 6,797,277, and 6,861,145.

The microencapsulation of phase change material is well-known in the art, and is disclosed for example, in U.S. Pat. No. 4,708,812 (encapsulation of solid phase change material for thermal energy storage with a shell of an elastomeric condensation polymer, such as polyurethane-urea, to permit for the change in volume accompanying phase transitions), incorporated hereby by reference.

The preferred size of the microcapsules employed depends upon their location in the roofing material. When microcapsules containing phase change materials are distributed in roofing granule coatings, the PCM microcapsules preferably have an average size that is less than the thickness of the coating layer. Thus, when the PCM microcapsules are distributed in a roofing granule coating, the PCM microcapsules preferably have an average size of from about 1 micrometer to 100 micrometers, and more preferably from about 2 micrometers to 50 micrometers. When PCM microcapsules are distributed in the core of a PCM roofing granule, the PCM microcapsules preferably have an average size that is less than about one-half the average size of the cores. Thus, when the PCM microcapsules are distributed in the roofing granule cores, the PCM microcapsules preferably have an average size of from about 0.1 millimeters to 10 millimeters, more preferably from about 0.5 millimeters to 2 millimeters. When the PCM microcapsules are distributed in a roofing material membrane, the PCM microcapsules preferably have an average size that is less than the membrane thickness. Thus, when PCM microcapsules are distributed in a roofing material membrane, the PCM microcapsules preferably have an average size of from about 1 micrometer to 100 micrometers, and more preferably from about 2 micrometers to 50 micrometers.

Preferably, the microcapsules formed have an average size of from about 200 micrometers to about 5 millimeters, and more preferably of from about 400 micrometers to about 2 mm.

In some cases, for example, when phase change material is to be incorporated in roofing granules, microcapsules containing phase change material can be themselves encapsulated in macrocapsules (having an average particle size of, for example, from about 0.1 to 10 mm), such as disclosed in U.S. Pat. No. 6,703,127. The macrocapsules can then in turn be agglomerated with inert material to form roofing granules, which can be subsequently coated with reflective material, etc. Alternatively, the phase change material can be adsorbed on a finely divided solid microporous material such as amorphous silica or a zeolite, such as disclosed in U.S. Pat. No. 6,063,312.

Phase changes are typically accompanied by volume changes. Although the extent of the volume change accompanying a solid to liquid phase transition or a solid-solid phase transition is typically much smaller than the volume change accompanying a liquid to gas phase transition, the contemplated volume change should be accommodated in preparing the roofing materials of the present invention. Thus, when the dispersed phase change material is packaged in microcapsules, it is preferred that the microcapsule wall be formed from an elastomeric polymer to permit the expansion and contraction of the phase change material undergoing the phase transition. In the alternative, the phase change material can be packaged within the microcapsules with sufficient void volume to accommodate the contemplated phase change without rupture of the microcapsule walls. This can be accomplished, for example, by employing a volatile diluent for the phase change material. A solution of the phase change material and the diluent is encapsulated. The diluent can be selected so that it can escape through the microcapsule walls after formation of the microcapsules.

The roofing materials of the present invention can include phase change materials in any one or more of several different locations, depending on the specific structure of the roofing material. For example, when the roofing material is a membrane formed from a thermoplastic polymeric material such as thermoplastic polyolefin (TPE), the phase change material can be distributed as a discontinuous phase within a continuous phase formed by the thermoplastic polymeric material. As another example, when the roofing material is an asphalt roofing shingle including both a bituminous membrane and a surface coating of protective roofing granules, the phase change material can be included in the roofing granules, in the bituminous membrane, or both. Roofing granules typically include a core material, which can be covered with a layer including colorants to provide an attractive appearance. In the present invention, the phase change material can be included in the roofing granule core, in one or more coating(s) for the core, or in both the core and the coating(s), to form “PCM” roofing granules.

When phase change material is located in the core of the roofing granule, the core can be composed of a single type phase change material, a mixture of two or more types of phase change materials, or a mixture of one or more types of phase change materials with one or more types of non-phase change materials. Such roofing granule cores can be prepared by initially preparing a porous core of non-phase change material, such as disclosed for example in U.S. Patent Publication No. 2004-0258835, and subsequently immersing the porous cores in the liquid phase of a suitable phase change material to permit the phase change material to be drawn into the cores by osmotic forces.

Alternatively, the cores of PCM roofing granules can be composed of an agglomeration of microcapsules containing phase change materials and other material, such as inert mineral materials. In the alternative, the cores of PCM roofing granules can be formed from microcapsules containing phase change materials, and dispersed in a continuous core binder material, such as a siliceous binder material.

When phase change material is located in the outside the core of the roofing granule, the core can be coated with one or more layers. For example, the core can be formed from an inert mineral material, and coated with a layer of microcapsules including phase change material dispersed in a continuous binder. The layer including the microcapsules can in turn be covered with an outer layer that does not contain phase change materials, but instead may contain colorants, pigments, solar heat reflection pigments, algae-resistance materials such as copper oxide and zinc oxide, and the like.

The PCM roofing granules of the present invention can include solar heat reflection pigments, examples of which include white titanium dioxide pigments provided by Du Pont de Nemours, P.O. Box 8070, Wilmington, Del. 19880.

The PCM roofing granules of the present invention can include algae-resistance materials, examples of which include copper materials, zinc materials, and mixtures thereof. For example, cuprous oxide and/or zinc oxide, or a mixture thereof, can be used. The copper materials that can be used in the present invention include cuprous oxide, cupric acetate, cupric chloride, cupric nitrate, cupric oxide, cupric sulfate, cupric sulfide, cupric stearate, cupric cyamide, cuprous cyamide, cuprous stannate, cuprous thiocyanate, cupric silicate, cuprous chloride, cupric iodide, cupric bromide, cupric carbonate, cupric fluoroborate, and mixtures thereof. The zinc materials can include zinc oxide, such as French process zinc oxide, zinc sulfide, zinc borate, zinc sulfate, zinc pyrithione, zinc ricinoleate, zinc stearate, zinc chromate, and mixtures thereof. In one embodiment, it is preferred that the phase change roofing materials of the present invention include at least one algaecide, the at least one algaecide preferably comprising cuprous oxide. In this case, it is preferred that the cuprous oxide comprises at least 2 percent of the roofing granule. In another embodiment, the at least one algaecide preferably comprises zinc oxide, and it is preferred that the zinc oxide comprises at least 0.1 percent by weight of the roofing granule.

When a mixed algaecide is employed, the algae-resistant material preferably comprises a mixture of cuprous oxide and zinc oxide.

The PCM roofing granules of the present invention can be colored using conventional coatings pigments. Examples of coatings pigments that can be used include those provided by the Color Division of Ferro Corporation, 4150 East 56th St., Cleveland, Ohio 44101, and produced using high temperature calcination, including PC-9415 Yellow, PC-9416 Yellow, PC-9158 Autumn Gold, PC-9189 Bright Golden Yellow, v-9186 Iron-Free Chestnut Brown, V-780 Black, V0797 IR Black, V-9248 Blue, PC-9250 Bright Blue, PC-5686 Turquoise, V-13810 Red, V-12600 Camouflage Green, V12560 IR Green, V-778 IR Black, and V-799 Black.

Roofing granules typically comprise crushed and screened mineral materials, which are subsequently coated with a binder containing one or more coloring pigments, such as suitable metal oxides. The granules are employed to provide a protective layer on asphaltic roofing materials such as shingles, and to add aesthetic values to a roof.

In preparing PCM roofing granules according to the present invention, one or more exterior coating layers can be applied to the base particles. The exterior coating layers can include phase change material, and preferably includes a suitable coating binder. The coating binder can be an inorganic or organic material, and is preferably formed from a polymeric organic material or a silicaceous material, such as a metal-silicate binder, for example an alkali metal silicate, such as sodium silicate. The choice of binder preferably reflects the choice of the phase change material, and whether the phase change material is contained in microcapsules and if so, the nature of the material from which the microcapsule is formed. Preferably, the binder is selected to avoid loss or degradation of the phase change material or the microcapsule wall during cure of the binder. Similarly, when the phase change material is incorporated in the roofing granule core and a binder material for the core is employed, the core binder material is also preferably selected so that loss or degradation of the phase change material or the microcapsule wall material (if present) is avoided during cure of the core binder material.

When a metal-silicate binder is employed in the preparation of PCM granules of the present invention, the binder preferably includes a heat-reactive aluminosilicate material, such as clay, preferably, kaolin. Alternatively, the metal silicate binder can be insolubilized chemically by reaction with an acidic material, for example, ammonium chloride, aluminum chloride, hydrochloric acid, calcium chloride, aluminum sulfate, or magnesium chloride, such as disclosed in U.S. Pat. Nos. 2,591,149, 2,614,051, 2,898,232 and 2,981,636, each incorporated herein by reference, or other acidic material such as aluminum fluoride. In another alternative, the binder can be a controlled release sparingly water soluble glass such as a phosphorous pentoxide glass modified with calcium fluoride, such as disclosed in U.S. Pat. No. 6,143,318, incorporated herein by reference.

If the phase change material is to be incorporated only in one or more exterior coatings for the roofing granules, inert base particles can be employed. Suitable inert base particles, for example, mineral particles with size passing #8 mesh and retaining on #70 mesh, can be coated with a combination of a phase change material, metal-silicate binder, kaolin clay, color pigments such as metal oxide pigments to reach desirable colors, followed by a heat treatment to obtain a durable coating.

When the PCM roofing granules are fired at an elevated temperature, such as at conditions of at least about 800 degrees F., and preferably at temperatures from about 1,000 to about 1,200 degrees F., the clay binder densifies to form strong particles.

Examples of clays that can be employed in preparing PCM roofing granules for the present invention include kaolin, other aluminosilicate clays, Dover clay, bentonite clay, etc.

In the alternative, a suitable silicaceous binder can be formed from sodium silicate, modified by the addition of at least one of sodium fluorosilicate, aluminum fluoride, or Portland cement.

In one presently preferred embodiment, the roofing material of the present invention includes at least one solar heat reflective material.

The solar heat-reflective material can be an infrared-reflective functional pigment selected from the group consisting of light-interference platelet pigments including mica, light-interference platelet pigments including titanium dioxide, mirrorized silica pigments based upon metal-doped silica, and alumina.

When alumina is employed as the at least one solar heat-reflective pigment, the alumina (aluminum oxide) preferably has a particle size less than #40 mesh (425 microns), preferably between 0.1 micron and 5 microns, and more preferably between 0.3 micron and 2 microns. It is preferred that the alumina includes greater than 90 percent by weight. Al2O3, and more preferably, greater than 95% by weight Al2O3.

The at least one solar heat-reflective pigment can comprise a solid solution including iron oxide, such as disclosed in U.S. Pat. No. 6,174,360, incorporated herein by reference. The solar heat-reflective pigment can also comprise a near infrared-reflecting composite pigment such as disclosed in U.S. Pat. No. 6,521,038, incorporated herein by reference. Composite pigments are composed of a near-infrared non-absorbing colorant of a chromatic or black color and a white pigment coated with the near infrared-absorbing colorant. Near-infrared non-absorbing colorants that can be used in the present invention are organic pigments such as organic pigments including azo, anthraquinone, phthalocyanine, perinone/perylene, indigo/thioindigo, dioxazine, quinacridone, isoindolinone, isoindoline, diketopyrrolopyrrole, azomethine, and azomethine-azo functional groups. Preferred black organic pigments include organic pigments having azo, azomethine, and perylene functional groups.

Examples of near infrared-reflective pigments available from the Shepherd Color Company, Cincinnati, Ohio, include Arctic Black 10C909 (chromium green-black), Black 411 (chromium iron oxide), Brown 12 (zinc iron chromite), Brown 8 (iron titanium brown spinel), and Yellow 193 (chrome antimony titanium).

Light-interference platelet pigments are known to give rise to various optical effects when incorporated in coatings, including opalescence or pearlescence. Surprisingly, light-interference platelet pigments have been found to provide or enhance infrared-reflectance of roofing granules coated with compositions including such pigments.

Examples of light-interference platelet pigments that can be employed in the process of the present invention include pigments available from Wenzhou Pearlescent Pigments Co., Ltd., No. 9 Small East District, Wenzhou Economical and Technical Development Zone, Peoples Republic of China, such as Taizhu TZ5013 (mica, rutile titanium dioxide and iron oxide, golden color), TZ5012 (mica, rutile titanium dioxide and iron oxide, golden color), TZ4013 (mica and iron oxide, wine red color), TZ4012 (mica and iron oxide, red brown color), TZ4011 (mica and iron oxide, bronze color), TZ2015 (mica and rutile titanium dioxide, interference green color), TZ2014 (mica and rutile titanium dioxide, interference blue color), TZ2013 (mica and rutile titanium dioxide, interference violet color), TZ2012 (mica and rutile titanium dioxide, interference red color), TZ2011 (mica and rutile titanium dioxide, interference golden color), TZ1222 (mica and rutile titanium dioxide, silver white color), TZ1004 (mica and anatase titanium dioxide, silver white color), TZ4001/600 (mica and iron oxide, bronze appearance), TZ5003/600 (mica, titanium oxide and iron oxide, gold appearance), TZ1001/80 (mica and titanium dioxide, off-white appearance), TZ2001/600 (mica, titanium dioxide, tin oxide, off-white/gold appearance), TZ2004/600 (mica, titanium dioxide, tin oxide, off-white/blue appearance), TZ2005/600 (mica, titanium dioxide, tin oxide, off-white/green appearance), and TZ4002/600 (mica and iron oxide, bronze appearance).

Examples of light-interference platelet pigments that can be employed in the process of the present invention also include pigments available from Merck KGaA, Darmstadt, Germany, such as Iriodin® pearlescent pigment based on mica covered with a thin layer of titanium dioxide and/or iron oxide; Xirallic™ high chroma crystal effect pigment based upon Al2O3 platelets coated with metal oxides, including Xirallic T 60-10 WNT crystal silver, Xirallic T 60-20 WNT sunbeam gold, and Xirallic F 60-50 WNT fireside copper; Color Stream™ multi color effect pigments based on SiO2 platelets coated with metal oxides, including Color Stream F 20-00 WNT autumn mystery and Color Stream F 20-07 WNT viola fantasy; and ultra interference pigments based on TiO2 and mica.

Examples of mirrorized silica pigments that can be employed in the process of the present invention include pigments such as Chrom Brite™ CB4500, available from Bead Brite, 400 Oser Ave, Suite 600, Hauppauge, N.Y. 11788.

The solar heat-reflective material can also be a white pigment. Examples of white pigments that can be employed in the present invention include rutile titanium dioxide, anatase titanium dioxide, lithopone, zinc sulfide, zinc oxide, lead oxide, and void pigments such as spherical styrene/acrylic beads (Ropaque® beads, Rohm and Haas Company), and hollow glass beads having pigmentary size for increased light scattering. Preferably, the at least one solar heat-reflective pigment is selected from the group consisting of titanium dioxide, zinc oxide and zinc sulfide.

Preferably, the at least one solar heat reflective roofing material has greater than 40% total reflectance between 700 nm to 2500 nm of solar radiation.

When the at least one solar heat-reflective material is incorporated in a coating composition, it is preferred that the at least one solar heat-reflective pigment comprises from about 10 percent by weight to about 40 percent by weight of the coating composition. It is more preferred that the at least one solar heat-reflective pigment comprises from about 20 percent by weight to about 30 percent by weight of the coating composition.

Referring now to the figures there is shown in FIG. 1, a schematic illustration of a solar heat responsive roofing material 10 according to a first embodiment of the present invention. The solar heat responsive roofing material comprises a flexible thermoplastic polyolefin membrane 12 having finely divided white titanium dioxide pigment particles dispersed therein to provide for solar heat reflectance, reinforced with a polyester scrim 14. The thermoplastic olefin membrane constitutes a continuous phase, in which is dispersed as a discontinuous phase a multitude of elements 16 comprising phase change material 18 having a fusion temperature between 50 degrees C. and 95 degrees C. encapsulated in a flexible elastomeric wall 20. The thermoplastic polyolefin membrane 12 has a thickness of about 0.15 cm, and the average size of the PCM microcapsules 16 is about 0.03 cm.

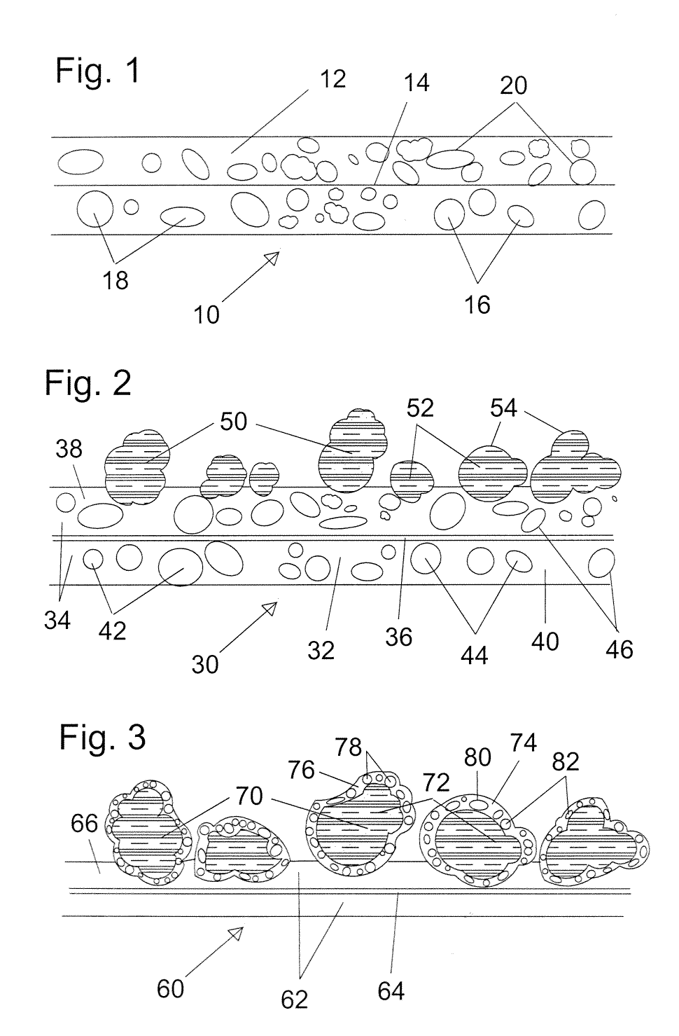

FIG. 2 is a schematic illustration of a solar heat responsive roofing material 30 according to a second embodiment of the present invention. In this embodiment, a membrane 32 is formed from a pair of continuous bituminous layers 34 sandwiching a reinforcing glass fiber scrim 36. The upper bituminous layer 38 and lower bituminous layer 40 form continuous phase in which is dispersed a discontinuous phase formed from microcapsules 42 comprising phase change material 44 having a fusion temperature between 50 degrees C. and 95 degrees C. encapsulated in a flexible elastomeric wall 46. Partially embedded in the upper surface of the upper bituminous layer 38 are a plurality of roofing granules 50 comprising an inert mineral core 52 coated with a layer 54 of a cured coating composition. The coating composition can include conventional metal oxide pigments, and/or one or more solar reflective pigments, such as titanium dioxide.

FIG. 3 is a schematic illustration of solar heat responsive roofing material 60 according to a third embodiment of the present invention. In this embodiment, a membrane is formed by a pair of bituminous layers 62 reinforced by an embedded reinforcing scrim 64 of glass fibers. The top or upper bituminous layer 66 is surfaced with a plurality of roofing granules 70 formed from an inert mineral core 72 and covered with a layer 74 of a cured coating composition. The coating composition layer 74 includes a continuous coating binder 76 in which are dispersed microcapsules 78 having an exterior wall 80 encapsulating a core 82 of phase change material. The coating composition layer 74 can also include conventional metal oxide colorants as well as, optionally, one or more solar reflective pigments.

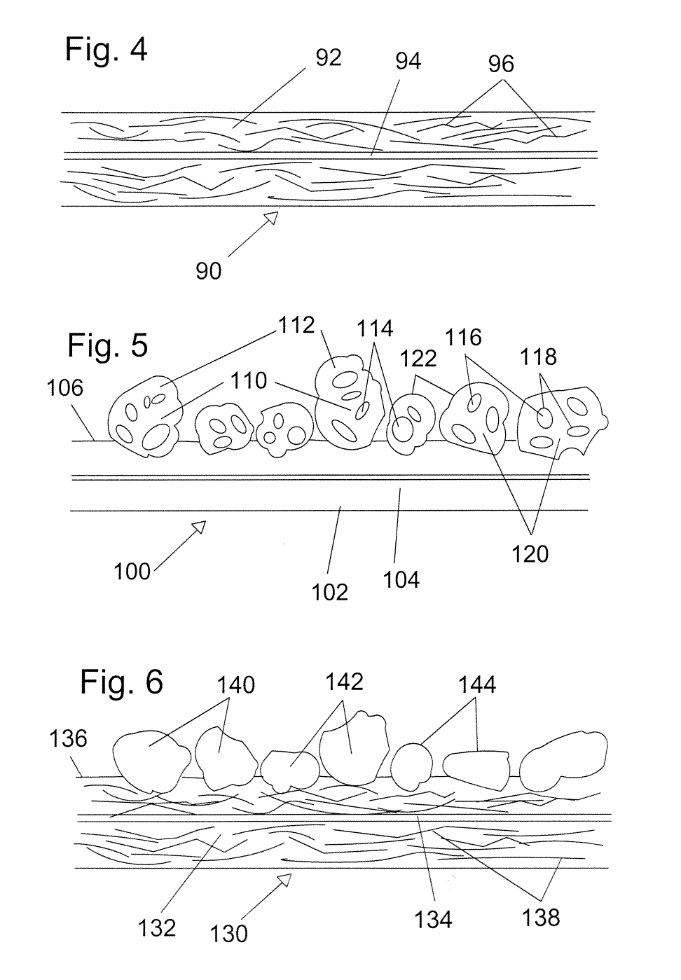

FIG. 4 is a schematic illustration of a solar heat responsive roofing material 90 according to a fourth embodiment of the present invention. In this embodiment, the roofing material 90 includes a bituminous membrane 92 reinforced with a fibrous scrim 94. The scrim 94 includes fibers formed from a phase change material as well as conventional glass fibers. Fibers 96 formed from the phase change material are also dispersed above and below the scrim 94 within the bituminous membrane 92.

FIG. 5 is a schematic illustration of a solar heat responsive roofing material 100 according to a fifth embodiment of the present invention. In this embodiment, the roofing material 100 includes a bituminous membrane 102 reinforced with a scrim 104 formed from glass fibers. Partially embedded in the upper surface 106 of the bituminous membrane 102 are a plurality of composite roofing granules 110 having nuclei 112 formed from capsules 114 including cores 116 of phase change material covered with an exterior wall 118 bound together with a siliceous matrix 120, and covered with a layer 122 of a cured coating composition in which are dispersed conventional iron oxide pigments.

FIG. 6 is a schematic illustration of a solar heat responsive roofing material 130 according to a sixth embodiment of the present invention. In this embodiment, the roofing material 130 includes a bituminous membrane 132 reinforced with a fibrous scrim 134. The scrim 134 includes fibers formed from a phase change material as well as conventional glass fibers. Fibers 138 formed from the phase change material are also dispersed above and below the scrim 134 within the bituminous membrane 132. Partially embedded in the upper surface 136 of the bituminous membrane 132 are a plurality of roofing granules 140 comprising an inert mineral core 142 coated with a layer 144 of a cured coating composition. The coating composition can include conventional metal oxide pigments, and/or one or more solar reflective pigments, such as titanium dioxide.

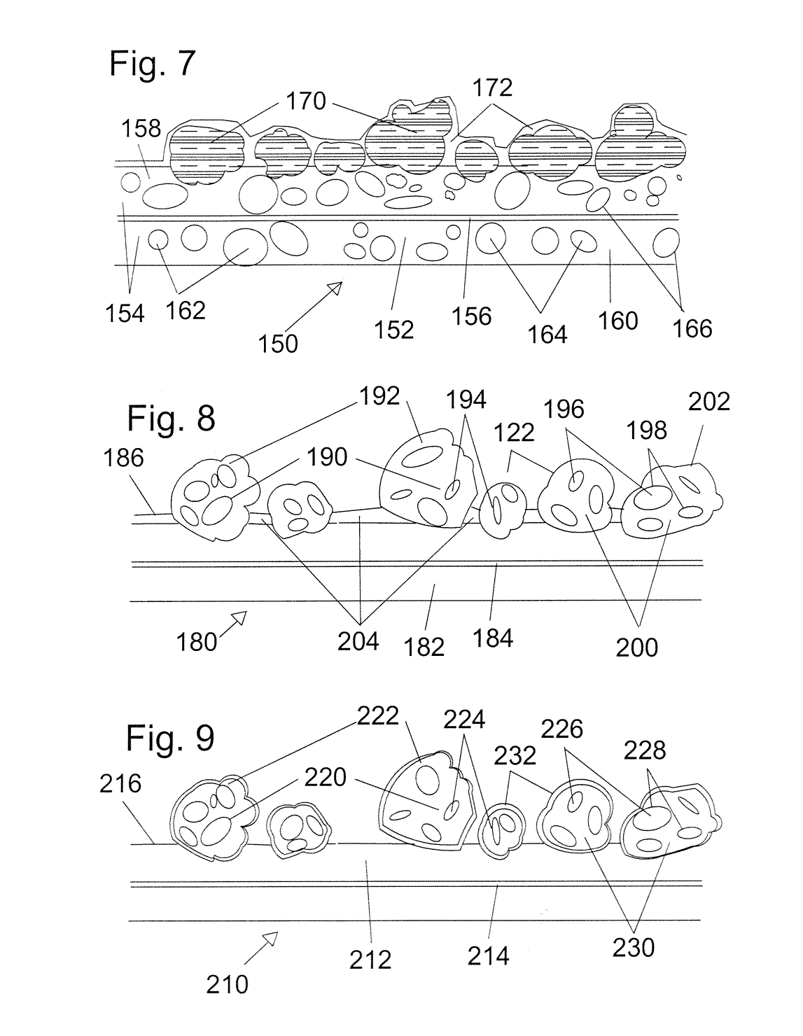

FIG. 7 is a schematic illustration of a reflective, solar heat responsive roofing material 150 according to a seventh embodiment of the present invention. In this embodiment, a membrane 152 is formed from a pair of continuous bituminous layers 154 sandwiching a reinforcing glass fiber scrim 156. The upper bituminous layer 158 and lower bituminous layer 160 form continuous phase in which is dispersed a discontinuous phase formed from microcapsules 162 comprising phase change material 164 having a fusion temperature between 50 degrees C. and 95 degrees C. encapsulated in a flexible elastomeric wall 166. Partially embedded in the upper surface of the upper bituminous layer 158 are a plurality of roofing granules 170 comprising an inert mineral material. The roofing granules 170 and the upper surface of the upper layer 158 are coated with a layer 172 of a cured roof coating composition. The roof coating composition includes one or more solar reflective pigments, such as titanium dioxide, dispersed in an elastomeric binder.

FIG. 8 is a schematic illustration of a solar heat responsive roofing material 180 according to an eighth embodiment of the present invention. In this embodiment, the roofing material 180 includes a bituminous membrane 182 reinforced with a scrim 184 formed from glass fibers. Partially embedded in the upper surface 186 of the bituminous membrane 182 are a plurality of composite roofing granules 190 having nuclei 192 formed from capsules 194 including cores 196 of phase change material covered with an exterior wall 198 bound together with a siliceous matrix 200, and covered with a layer 202 of a cured coating composition in which are dispersed conventional iron oxide pigments. The upper surface of the upper layer 186 is coated with a layer 204 of a cured roof coating composition. The roof coating composition includes one or more solar reflective pigments, such as titanium dioxide, dispersed in an elastomeric binder.

FIG. 9 is a schematic illustration of solar heat responsive roofing material 210 according to a ninth embodiment of the present invention. In this embodiment, the roofing material 210 includes a bituminous membrane 212 reinforced with a scrim 214 formed from glass fibers. Partially embedded in the upper surface 216 of the bituminous membrane 212 are a plurality of composite roofing granules 220 having nuclei 222 formed from capsules 224 including cores 226 of phase change material covered with an exterior wall 228 bound together with a siliceous matrix 230, and covered with a layer 232 of a cured coating composition including one or more solar reflective pigments, such as titanium dioxide, dispersed in a siliceous binder.

The PCM roofing granules of the present invention can be employed in the manufacture of roofing products, such as asphalt shingles, using conventional roofing production processes. Typically, bituminous roofing products are sheet goods that include a non-woven base or scrim formed of a fibrous material, such as a glass fiber scrim. The base is coated with one or more layers of a bituminous material such as asphalt to provide water and weather resistance to the roofing product. One side of the roofing product is typically coated with mineral granules to provide durability, reflect heat and solar radiation, and to protect the bituminous binder from environmental degradation. The PCM roofing granules of the present invention can be mixed with conventional roofing granules, and the granule mixture can be embedded in the surface of such bituminous roofing products using conventional methods. Alternatively, the PCM granules of the present invention can be substituted for conventional roofing granules in the manufacture of bituminous roofing products to provide those roofing products with solar heat storage.

Bituminous roofing products are typically manufactured in continuous processes in which a continuous substrate sheet of a fibrous material such as a continuous felt sheet or glass fiber mat is immersed or coated in a bath of hot, fluid bituminous coating material so that the bituminous material saturates the substrate sheet and coats at least one side of the substrate. The reverse side of the substrate sheet can be coated with an anti-stick material such as a suitable mineral powder or a fine sand. Roofing granules are then distributed over selected portions of the top of the sheet, and the bituminous material serves as an adhesive to bind the roofing granules to the sheet when the bituminous material has cooled. The sheet can then be cut into conventional shingle sizes and shapes (such as one foot by three feet rectangles), slots can be cut in the shingles to provide a plurality of “tabs” for ease of installation, additional bituminous adhesive can be applied in strategic locations and covered with release paper or release film to provide for securing successive courses of shingles during roof installation, and the finished shingles can be packaged. More complex methods of shingle construction can also be employed, such as building up multiple layers of sheet in selected portions of the shingle to provide an enhanced visual appearance, or to simulate other types of roofing products.

The bituminous material used in manufacturing roofing products according to the present invention is derived from a petroleum processing by-product such as pitch, “straight-run” bitumen, or “blown” bitumen. The bituminous material can be modified with extender materials such as oils, petroleum extracts, and/or petroleum residues. The bituminous material can include various modifying ingredients such as polymeric materials, such as SBS (styrene-butadiene-styrene) block copolymers, resins, oils, flame-retardant materials, stabilizing materials, anti-static compounds, and the like. Preferably, the total amount by weight of such modifying ingredients is not more than about 15 percent of the total weight of the bituminous material. The bituminous material can also include amorphous polyolefins, up to about 25 percent by weight. Examples of suitable amorphous polyolefins include atactic polypropylene, ethylene-propylene rubber, etc. Preferably, the amorphous polyolefins employed have a softening point of from about 130 degrees C. to about 160 degrees C. The bituminous composition can also include a suitable filler, such as calcium carbonate, talc, carbon black, stone dust, or fly ash, preferably in an amount from about 10 percent to 70 percent by weight of the bituminous composite material.

Various modifications can be made in the details of the various embodiments of the processes, compositions and articles of the present invention, all within the scope and spirit of the invention and defined by the appended claims.

1. A solar heat responsive roofing material comprising:
a) a continuous phase; and
b) a discontinuous phase dispersed in the continuous phase, the discontinuous phase having a phase transition at a temperature between about 50 degrees Celsius and about 95 degrees Celsius.

2. Roofing material according to claim 1 wherein the phase transition temperature is between about 60 degrees Celsius and about 85 degrees Celsius.

3. Roofing material according to claim 1 wherein the discontinuous phase has a phase transition enthalpy of at least about 100 kilojoules per kg.

4. Roofing material according to claim 1 wherein the discontinuous phase constitutes at least ten percent by weight of the roofing material.

5. Roofing material according to claim 1 wherein the discontinuous phase comprises a lipophilic substance.

6. Roofing material according to claim 1 wherein the discontinuous phase comprises at least one heat-responsive substance selected from the group consisting of high temperature waxes and thermoplastic polymers.

7. Roofing material according to claim 6 wherein the thermoplastic polymer is selected from the group consisting of poly(vinyl ethyl ether), poly(vinyl n-butyl ether) and polychloroprene.

8. Roofing material according to claim 1 wherein the roof includes a base sheet having a bituminous coating, the continuous phase comprising the bituminous coating.

9. Roofing material according to claim 1 wherein the roof includes a plurality of coated roofing granules, the continuous phase comprising the roofing granule coating.

10. Roofing material according to claim 1 wherein the discontinuous phase is encapsulated in a plurality of capsules.

11. Roofing material according to claim 10 wherein the capsules include a capsule wall, the capsule wall being formed from a material selected from the group consisting of poly(meth)acrylates and polyurethanes.

12. Roofing material according to claim 10 wherein the capsules have an average size ranging from about 1 micrometer to 100 micrometers.

13. Roofing material according to claim 12 wherein the capsules have an average size ranging from about 2 micrometers to 50 micrometers.

14. Roofing material according to claim 1 wherein the discontinuous phase includes a plurality of fibers comprising phase change material.

15. A solar heat-responsive roofing material comprising:
a) a bituminous base sheet; and
b) a plurality of roofing granules, the roofing granules including a latent-heat storage material having a phase transition at a temperature between about 50 degrees Celsius and about 95 degrees Celsius.

16. A solar heat-responsive roofing material according to claim 15 wherein the phase transition temperature is between about 60 degrees Celsius and about 85 degrees Celsius.

17. A solar heat-responsive roofing material according to claim 15 wherein the heat storage material has a phase transition enthalpy of at least 100 kilojoules per kg.

18. A solar heat-responsive roofing material according to claim 15 wherein the heat storage material constitutes at least ten percent by weight of the roofing material.

19. A solar heat-responsive roofing material according to claim 15 wherein the heat storage material is a lipophilic substance.

20. A solar heat-responsive roofing material according to claim 15 wherein the heat storage material is selected from the group consisting of high temperature waxes and thermoplastic polymers.

21. A solar heat-responsive roofing material according to claim 20 wherein the thermoplastic polymer is selected from the group consisting of poly(vinyl ethyl ether), poly(vinyl n-butyl ether) and polychloroprene.

22. A solar heat-responsive roofing material according to claim 15 wherein the heat storage material is encapsulated in a plurality of capsules.

23. A solar heat-responsive roofing material according to claim 22 wherein the capsules include a capsule wall, the capsule wall being formed from a material selected from the group consisting of poly(meth)acrylates and polyurethanes.

24. A solar heat-responsive roofing material according to claim 22 wherein the capsules have an average size ranging from about 0.1 millimeters to 10 millimeters.

25. A solar heat-responsive roofing material according to claim 24 wherein the capsules have an average size ranging from about 0.5 millimeters to 2 millimeters.

26. A solar heat-responsive roofing material according to claim 15 wherein the heat storage material includes a plurality of fibers comprising phase change material.

27. A solar heat-responsive roofing material according to claim 15, further comprising at least one algaecide.

28. A solar heat-responsive roofing material comprising:
a) at least one solar-heat reflective material; and
b) at least one latent-heat storage material, the at least one latent-heat storage material having a phase transition at a temperature between about 50 degrees Celsius and about 95 degrees Celsius.

29. A solar heat-responsive roofing material according to claim 28 wherein the phase transition temperature is between about 60 degrees Celsius and about 85 degrees Celsius.

30. A solar heat-responsive roofing material according to claim 28 wherein the latent-heat storage material has a phase transition enthalpy of at least about 100 kilojoules per kg.

31. A solar heat-responsive roofing material according to claim 28 wherein the latent-heat storage material constitutes at least ten percent by weight of the roofing material.

32. A solar heat-responsive roofing material according to claim 28 wherein the latent-heat storage material is a lipophilic substance.

33. A solar heat-responsive roofing material according to claim 28 wherein the discontinuous phase comprises at least one heat-responsive substance selected from the group comprising high temperature waxes and thermoplastic polymers.

34. A solar heat-responsive roofing material according to claim 31 wherein the thermoplastic polymer is selected from the group consisting of poly(vinyl ethyl ether), poly(vinyl n-butyl ether) and polychloroprene.

35. A solar heat-responsive roofing material according to claim 28 wherein the at least one solar heat reflective roofing material has greater than 40% total reflectance between 700 nm to 2500 nm of solar radiation.

36. A solar heat-responsive roofing material according to claim 28 comprising:
(a) a continuous phase; and
(b) a discontinuous phase dispersed in the continuous phase, the discontinuous phase including the latent-heat storage material.

37. A solar heat-responsive roofing material according to claim 36 wherein the roofing material includes a base sheet having a bituminous coating, the continuous phase comprising the bituminous coating.

38. A solar heat-responsive roofing material according to claim 36 wherein the roofing material includes a plurality of coated roofing granules, the continuous phase comprising the roofing granule coating.

39. A solar heat-responsive roofing material according to claim 36 wherein the discontinuous phase is encapsulated in a plurality of capsules.

40. A solar heat-responsive roofing material according to claim 39 wherein the capsules include a capsule wall, the capsule wall being formed from a material selected from the group consisting of poly(meth)acrylates and polyurethanes.

41. A solar heat-responsive roofing material according to claim 39 wherein the capsules have an average size ranging from about 1 micrometer to 100 micrometers.

42. A solar heat-responsive roofing material according to claim 39 wherein the capsules preferably have an average size ranging from about 2 micrometers to 50 micrometers.

43. A solar heat-responsive roofing material according to claim 28 comprising:
a) a bituminous base sheet; and
b) a plurality of roofing granules, the roofing granules including the latent heat storage material.

44. A solar heat-responsive roofing material according to claim 43 wherein the heat storage material is encapsulated in a plurality of capsules.

45. A solar heat-responsive roofing material according to claim 44 wherein the capsules include a capsule wall, the capsule wall being formed from a material selected from the group consisting of poly(meth)acrylates and polyurethanes.

46. A solar heat-responsive roofing material according to claim 44 wherein the capsules have a size ranging from about 0.1 millimeters to 10 millimeters.

47. A solar heat-responsive roofing material according to claim 44 wherein the capsules have a size ranging from about 0.5 millimeters to 2 millimeters.

48. A solar heat-responsive roofing material according to claim 28 further including a reflective coating, the solar-heat reflective material being dispersed in the reflective coating.

49. A solar heat-responsive roofing material according to claim 48 comprising:
a) a bituminous base sheet; and
b) a plurality of roofing granules, the roofing granules including the latent heat storage material.

50. A solar heat-responsive roofing material according to claim 49 wherein the reflective coating is applied to the bituminous base sheet.

51. A solar heat-responsive roofing material according to claim 49 wherein the reflective coating is applied to the roofing granules.

52. A solar heat-responsive roofing material according to claim 27 wherein the at least one algaecide is selected from the group consisting of cuprous oxide, cupric acetate, cupric chloride, cupric nitrate, cupric oxide, cupric sulfate, cupric sulfide, cupric stearate, cupric cyamide, cuprous cyamide, cuprous stannate, cuprous thiocyanate, cupric silicate, cuprous chloride, cupric iodide, cupric bromide, cupric carbonate, cupric fluoroborate, French process zinc oxide, non-French process zinc oxide, zinc sulfide, zinc borate, zinc sulfate, zinc pyrithione, zinc ricinoleate, zinc stearate, zinc chromate, and mixtures thereof.

53. A solar heat-responsive roofing material according to claim 27 wherein the at least one algaecide is selected from copper oxide and zinc oxide.

54. A solar heat-responsive roofing material according to claim 27 wherein the at least one algaecide is cuprous oxide, and the cuprous oxide comprises at least 2 percent of the roofing granules.

55. A solar heat-responsive roofing material according to claim 27 wherein the at least one algaecide is zinc oxide, and the zinc oxide comprises at least 0.1 percent by weight of the roofing granules.
